(19) United States
(12) Patent Application Publication
(10) Pub. No.: US 2022/0060147 A1
(43) Pub. Date: Feb. 24, 2022

(54) LAMINATED CABLE ASSEMBLY

(71) Applicant: Erthos, Inc., Tempe, AZ (US)

(72) Inventor: Michael GLADKIN, Tempe, AR (US)

(21) Appl. No.: 17/316,647

(22) Filed: May 10, 2021

Related U.S. Application Data
(60) Provisional application No. 63/021,825, filed on May 8, 2020.

(51) Int. Cl. H02S 40/36; H02S 40/32; H01B 7/18

(52) U.S. Cl. CPC H02S 40/36; H02S 20/32; H01B 7/18; H02S 40/32

(57) ABSTRACT

Modular cable assembly for utility scale PV modules. The assemblies contain pairs of cables that connect strings of PV modules to inverters for commercial electrical production. In some versions, the pairs are sheathed or laminated to contain the cable pairs and position the modular connectors for simple connection to the PV cabling. In some versions, the inverter end of the cable assembly has the sheathing of laminate removed for efficiency of cable assembly.

### CROSS-REFERENCE TO RELATED APPLICATIONS

This application is related to and claims priority to U.S. Provisional Patent Application No. 63/021,825, filed on May 8, 2020. The entire content of the application is incorporated by this reference.

### BACKGROUND

Ground-Mount Solar Photovoltaic (PV) systems are commonly designed and implemented today as a renewable energy generation means for Utility-Scale Energy production providing both Transmission and Distribution level power to the US and Global Electrical Grids. Utility-Scale ground-mount solar PV systems use equipment from many producers of Fixed Tilt (FT) and Single Axis Tracking (SAT) structural racking systems, which are made from steel most commonly. Engineering firms design solar sites and arrays to site-specific geographical locations, solar insolation and weather data, and the authority having jurisdiction requirements to maximize module and string efficiency performance by orienting the modules to the sun at specified azimuth dependent FT angles and SAT orientations. Both FT and SAT Ground-Mount Solar systems depend on azimuth; the modules themselves are tilted toward the sun to maximize the full-day potential. Due to the high cost of the modules, solar module efficiency and performance are the primary drivers in Solar PV Plant design.

Module frames are typically constructed of aluminum, which provides the main mechanical fastening surface and structural support securing the module frame to the rigid structural racking system. The module construction, module dimensions, modules per structural row, racking structure specifications, tilt angle, row azimuth, length of each rigid row, and a maximum height above grade at full tilt and stow of modules are all considered during the engineering of the racking system. Wind load, snow load, seismic effects, soil geology, and soil bearing capacity critically affect racking system design. Exterior rows in an array typically see higher loading than interior rows and require more steel in pile cross-sections, structural racking components, and hardware. Based upon these many factors, the structural wind loading requirements, structural steel design, and pile embodiment is sized for the row and aggregate of rows to resist the wind loading for ground-mount solar FT and SAT systems. And soil corrosion is considered when designing the structural racking system. With ground-mount solar PV systems, DC-impressed current, and soil properties will both accelerate steel corrosion of embedded piles. Solar sites typically have a design life of over 25 years, so corrosion resistance and mitigation are critical to the solar plant's long-term life. Means of corrosion mitigation include pile galvanization increase thickness, sacrificial post steel, epoxy coatings, and cathodic protection for ground-mount solar PV systems.

ASCE site-specific wind 3-second gust criteria are utilized in the US to determine the maximum wind loading for each structural racking system per geographic location. Ground-Mount Solar rows can typically exceed 10 ft above grade in elevation at maximum tilt and rigid single rows near 300 feet in length with multiple structural piles per row. A typical 1500 V tracking system row will have three strings of 28 modules, 84 modules per row, and a maximum tilt of 55 degrees. Three (3) second gust wind speed criteria per location vary between 85 to 130 mph+ and depend upon location. Based on the maximum wind speed at a location, huge loads exist on both FT and Single Axis Tracker ground-mount solar PV systems due to their heights above grade, tilt angles of the modules, and large exposed surface areas of both front and back sides of the modules themselves. These loads from wind cause high-frequency cyclic loading on the modules and can commonly result in module microcracking over the plant's life. Module microcracking can prematurely degrade the modules leading to reduced efficiency and even complete failure.

Electrically, solar panels or modules are assemblies of multiple photovoltaic (PV) cells hardwired to form a single unit. Multiple solar panels are connected by stringing the positive and negative DC leads in series from module to module, typically by skip stringing. The number of modules in a single string is determined by the maximum DC voltage class of the solar site (1000 V or 1500 V typical for Utility-scale), module BIN class, and the number of modules in series determined by the module voltage specifications and site-specific temperature data. Multiple strings of modules per individual row aggregate DC power via DC Homerun conductors to either an intermediate Combiner Box or directly to an Inverter. Module frames are electrically bonded and grounded to the rack's structural components to prevent electrical safety hazards either by UL-listed hardware or approved bonding straps and assemblies. The racking components themselves are then bonded to the posts. The posts typically ground back to the inverter grounding system or ground ring utilizing an appropriately sized grounding conductor. Grounding systems for the steel racking structure can be complicated due to all the structural racking assembly components.

In each structural racking system and site design, row-to-row spacing is included. The shading of adjacent rows due to the sun's orientation and the structural system's tilt angle throughout the day is minimized, maximizing energy production. Row to row spacing typically means that a Ground Coverage Ratio (GCR) for a solar site utilizing FT or SAT technology is around GCR=35%, with row spacing typically varying between 15 to 21 ft center on center pile per row. Designs can increase the number of rows per array by shrinking the row spacing on a land plot. But shading increases when row spacing decreases. Daily energy production of the individual rows falls as they shade each other. Increasing the row-to-row spacing will decrease shading. Row to row spacing will also increase land use per MWac and the distance of rows to their respective electrical connections at the combiner boxes or inverters, increasing the total DC and AC cable required for a given solar site.

Multiple rows of modules form an Array, with multiple arrays aggregating power into typically 2 MWac, 3 MWac, or 4 MWac centralized inverter configurations called Blocks. One or more blocks are then aggregated to meet the total required Utility Interconnect MWac requirements of the Interconnection Agreement of the Utility (or merchant sale of power). Module BIN class (measured in Watts per panel), string size (number of modules connected in series), numbers of rows (3 strings per row typical), array sizes (collection of rows), and block sizes (collection of arrays) depend all on project-specific details including land constraints, geographical location, selected equipment sizes, utility interconnect requirements, and many other constraints. Block sizes vary by designer, project, and equipment.

FT and SAT racking systems' conventional goals have been to orient the module to the sun, resist mechanical loading generated by wind loads, snow loads, frost heave, and prevent structural failure because of soil corrosion. Plant design optimizes PV module alignment to the sun's incidence angle to maximize module efficiency. This optimization is important because PV modules have been the most expensive plant component by many orders of magnitude. By orienting the module to the sun and incorporating the cost of a ground-mount structural racking system as a balance of system cost, the lowest levelized cost of electricity (LCOE) for Utility Solar PV has historically been achieved.

As module prices have fallen by many orders of magnitude over the last decade and module efficiencies improved, an inflection point occurred where the LCOE model changed. Once the price of the modules dropped low enough, the increased efficiency of using structural racking systems no longer offset the expensive cost of the racking systems. Eliminating the structural racking system's capital costs, row-spacing requirements, installation costs, and associated components yields a lower LCOE than ground-mount systems.

Earth Mount Technology simplifies the solar array, its number of components, and its capital equipment and labor costs by eliminating the structural racking system between the module and the earth. Earth Mount Solar (as compared to ground-mount solar described above) places the module directly in contact with the earth without an intermediate structure between the module and the earth. The earth then becomes the primary structural supporting means, and the module and strings of modules are now oriented directly by the earth. Not optimizing the tilt angle or tracking loses efficiency. Still, capital equipment and labor cost reductions far outweigh the loss of module efficiency, resulting in a much lower LCOE than conventional ground-mount technologies.

Earth Mount Technology can produce the same energy as an FT or SAT profile using less than half the land per MWac of the solar PV plant. The technology reduces construction time by over 50%. It reduces snow loading and mechanical module wind stress. And it has a far lower LCOE compared with typical FT and SAT ground-mount systems. Placing the modules directly on the earth reduces wind loading and microcracking potential, eliminates steel corrosion, and increases expected plant life.

### SUMMARY

The disclosure relates to a modular cable assembly adapted to connect PV module strings, which have pairs of end modules, to an inverter wherein the assembly has cable pairs and a sheath containing the cable pairs. Depending on the version, the cable lengths for a particular cable pair equal the distances between the inverter and a respective one of the pairs of end modules. The cable sheath secures at least some module ends spaced apart, sometimes in a stair-stepped arrangement. The cable sheath secures at least some inverter ends even with each other.

The sheath groups the cables in one or more vertical or flat layers. In some versions the inverter end of the assembly has a region that doesn't have sheathing. The sheathing can be a single piece that wraps around the cable pairs or can have more than one piece laminated or otherwise adhered to each other around the cable pairs. The sheathing can be certified for outdoor or direct burial use and need not contain the same material as the insulation on the cables. The assembly may have greater than 50 cable pairs. The ends such as the module ends of the cables can be attached to standard solar module connectors.

### BRIEF DESCRIPTION OF THE DRAWINGS

FIG. 1A is a cross-section of a cable assembly discussed in this disclosure.

FIG. 1B is a perspective view of a cable assembly discussed in this disclosure.

FIG. 2 is a prospective view of a cable assembly discussed in this disclosure.

FIG. 3 is a schematic plan view of a cable assembly discussed in this disclosure.

FIG. 4 is a schematic plan view of a cable assembly with an associated module array.

FIG. 5 is another schematic plan view of a cable assembly with an associated module array.

FIG. 6 is a perspective view of an apparatus to prepare a cable assembly.

FIG. 7 is another perspective view of an apparatus to prepare a cable assembly.

FIG. 8 is another perspective view of an apparatus to prepare a cable assembly.

FIG. 9 is another perspective view of an apparatus to prepare a cable assembly.

### DETAILED DESCRIPTION

Unless defined otherwise, all technical and scientific terms used in this document have the same meanings as commonly understood by one skilled in the art to which the disclosed invention pertains. Singular forms—a, an, and the—include plural referents unless the context indicates otherwise. Thus, reference to “fluid” refers to one or more fluids, such as two or more fluids, three or more fluids, etc. When an aspect is said to include a list of components, the list is representative. If the component choice is limited explicitly to the list, the disclosure will say so. Listing components acknowledges that exemplars exist for each component and any combination of the components—including combinations that specifically exclude any one or any combination of the listed components. For example, “component A is chosen from A, B, or C” discloses exemplars with A, B, C, AB, AC, BC, and ABC. It also discloses (AB but not C), (AC but not B), and (BC but not A) as exemplars, for example. Combinations that one of ordinary skill in the art knows to be incompatible with each other or with the components' function in the invention are excluded from the invention, in some exemplars.

When an element or layer is called being “on”, “engaged to”, “connected to” or “coupled to” another element or layer, it may be directly on, engaged, connected, or coupled to the other element or layer, or intervening elements or layers may be present. When an element is called being “directly on”, “directly engaged to”, “directly connected to”, or “directly coupled to” another element or layer, there may be no intervening elements or layers present. Other words used to describe the relationship between elements should be interpreted in a like fashion (e.g., “between” versus “directly between”, “adjacent” versus “directly adjacent”, etc.).

Although the terms first, second, third, etc., may describe various elements, components, regions, layers, or sections, these elements, components, regions, layers, or sections should not be limited by these terms. These terms may only distinguish one element, component, region, layer, or section from another region, layer, or section. Terms such as “first”, “second”, and other numerical terms do not imply a sequence or order unless indicated by the context. Thus, a first element, component, region, layer, or section discussed below could be termed a second element, component, region, layer, or section without departing from this disclosure.

Spatially relative terms, such as “inner”, “outer”, “beneath”, “below”, “lower”, “above”, “upper” may be used for ease of description to describe one element or feature's relationship to another element or feature as illustrated in the figures. Spatially relative terms may be intended to encompass different orientations of the device in use or operation besides the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors interpreted.

The description of the exemplars has been provided for illustration and description. It is not intended to be exhaustive or to limit the invention. Individual elements or features of a particular exemplar are not limited to that exemplar but, where applicable, are interchangeable and can be used in a selected exemplar, even if not explicitly shown or described. The same may also be varied. Such variations are not a departure from the invention, and all such modifications are included within the invention's scope.

40 PV module

42 junction box

44 positive module lead

46 negative module lead

50 inverter

100 laminated cable assembly

110 cable

111 insulation

112 conductor

120 upper sheet

130 lower sheet

140 seam

210 male connector

220 female connector

250 delaminated region

600 laminating machine

610 case

620 large roller

630 small roller

640 bearings

710 tension roller

910 laminated cable assembly reel

The Laminated Cable Assembly (LCA) eliminates the need to run single homerun conductors from the end of the module strings to the inverter. It increases the cable length precision while reducing variable installation quality by moving some of the assembly work into a factory. This device replaces using cable reels of single-stranded 2 kV PV wire (or similar) in the field, reducing installation time, cable waste, incorrect cable connections, incorrect cable labelling, cable damage, and cable waste. In addition, the laminated sheeting or other outer shielding (collectively, sheathing) protects the connectors (Amphenol, MC4, or similar) and the cabling during transit and installation until the cables are finally terminated. The outer shielding reduces the potential for soiling and damage to connector ends typically occurring between initial delivery and field installation and final connecting and circuit testing.

The LCA is created in the factory by running the individual pre-determined length conductors (with connectors installed) between a sticky top sheet and bottom sheet. In some versions, the sheets are made of fiberglass or plastic. And the connectors sit as needed for installation and electrical connection to the module string ends. Sheathing can have pre-printed, laser-etched cable identification. Alternatively, the sheathing can be marked in other ways known to those of ordinary skill in the art. In some exemplars, these markings show the plant or array location for each conductor. In these or other exemplars, these markings indicate cable terminations, which eliminates the need for field labeling and the guesswork involved in cutting cables to length.

The LCA can be prepared as typical structured cabling or sheathed cable. Afterward, the pre-assembled LCA is then rolled onto a reusable spool, such as for shipping. This assembly alleviates damage and soiling before cable connection. In use, the installer will roll out the assembly in its respective location, slice the plastic sheet or sheathing at each pre-installed MC4 end to expose the connection point, and mate the end with its corresponding module string terminal.

At the inverter side, the installer may run the cable into the inverter, cut the ends to length, label the ends, and connect them to the respective inverter terminal.

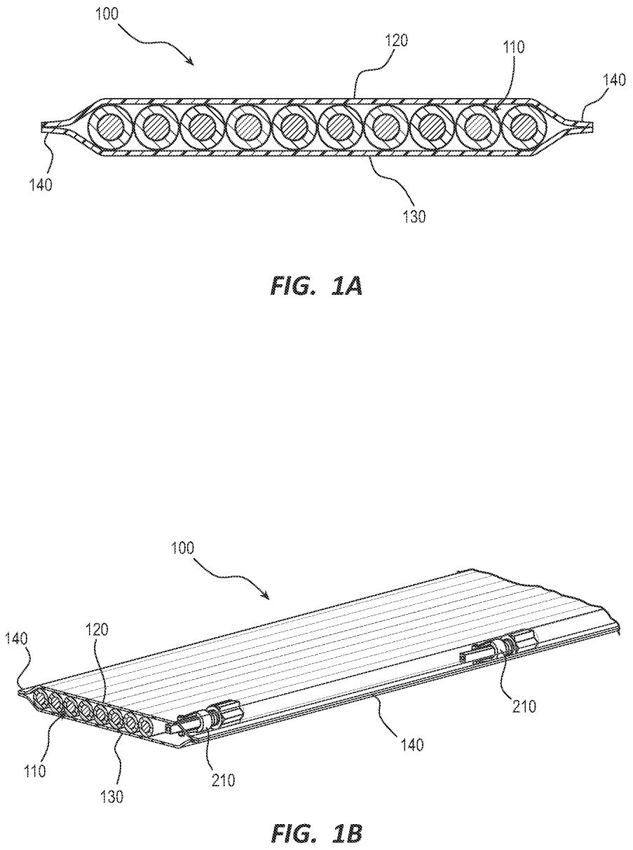

FIG. 1A depicts a cross-section of an LCA 100. As depicted, the assembly 100 has several cables 110 lying flat sandwiched between an upper sheet 120 and a lower sheet 130. Alternative versions exist in which upper sheet 120 and lower sheet 130 are a single outer sheath extruded over LCA 110. This figure depicts upper sheet 120 and lower sheet 130 are joined at seam 140. In some exemplars, seam 140 results from a connection between upper sheet 120 and lower sheet 130. In these or other exemplars, seam 140 results from heat bonding, pressure bonding, or both.

FIG. 1A also depicts the insulation 111 of cable 110 and the cable 112 of cable 110. In some exemplary, the cable is single-stranded. In these or other exemplars, the cable is #8, #10, or #12 AWG. The cable style, gauge, conductor material, insulation material, and sheathing or laminating material may be standard material as is commonly used in related applications.

FIG. 1B depicts a perspective view of LCA 100. As with FIG. 1A, FIG. 1B shows cable 110. LCA 100 has one or more pairs of cable 110. In some examples, individual cables 110 have different lengths. In some exemplars, distinct pairs have different average lengths than other pairs.

An LCA 100 lies along a row of PV module strings and serves as the electrical connections between the positive and negative ends of the strings and the inverter. Consecutive PV module strings extend in rows. Sometimes, more than one string module lays along the row. Consecutive PV module strings extend in one direction, while the modules of an individual string may extend perpendicular to the row direction. For this disclosure, the direction perpendicular to the row direction is the column direction.

In some exemplars, the length of a string is two or more modules. When the string has only two modules, the modules lay along the row direction. In exemplars with more than two modules, sometimes the string has two modules lying in the row direction with additional string modules lying in columns at right angles to the string modules lying in the row direction. The strings are connected in series, parallel, or series and parallel and then to cables 110 in LCA 100.

The distance between the module ends of a string and the inverter is different. For example, for arrangements with an inverter at a row end, each module and each cable end are sequentially further from the inverter. Cable 110 has a length proportional to the distance between the module and the inverter connection. In some versions, the row layout causes a stair-step configuration in the lengths of cables 110. This stair-step configuration can be seen in the figures.

FIG. 1B also depicts male and female connectors attached to the module ends of cables 110. These attach to corresponding terminals of string modules.

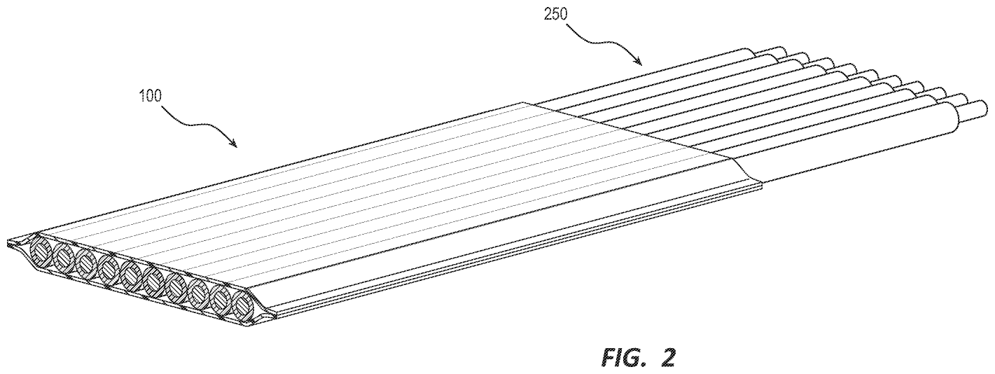

FIG. 2 depicts LCA 100 as in FIG. 1a. In FIG. 2, LCA 100 has a delaminated region 250 in which upper sheet 120 and lower sheet 130 of the laminate have been cut or peeled back, leaving cables 110 unlimited.

In some exemplars, delaminated region 250, not having laminate around cables 110, allows cables 110 to fit through conduit or other cable runs or cable passageways.

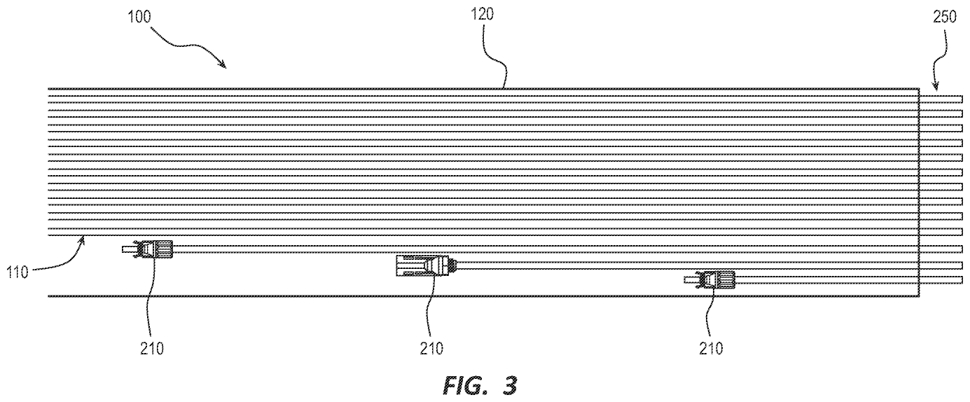

FIG. 3 is a plan view of LCA 100. This figure also shows male connector's 210 and female connectors 220. The stair-step shape of LCA 100 can also be seen in this figure.

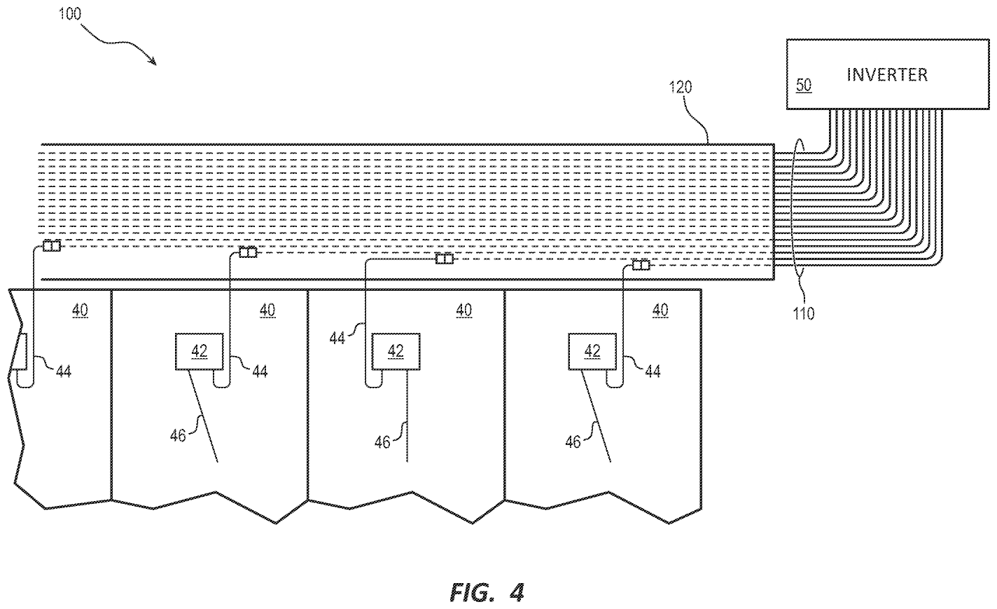

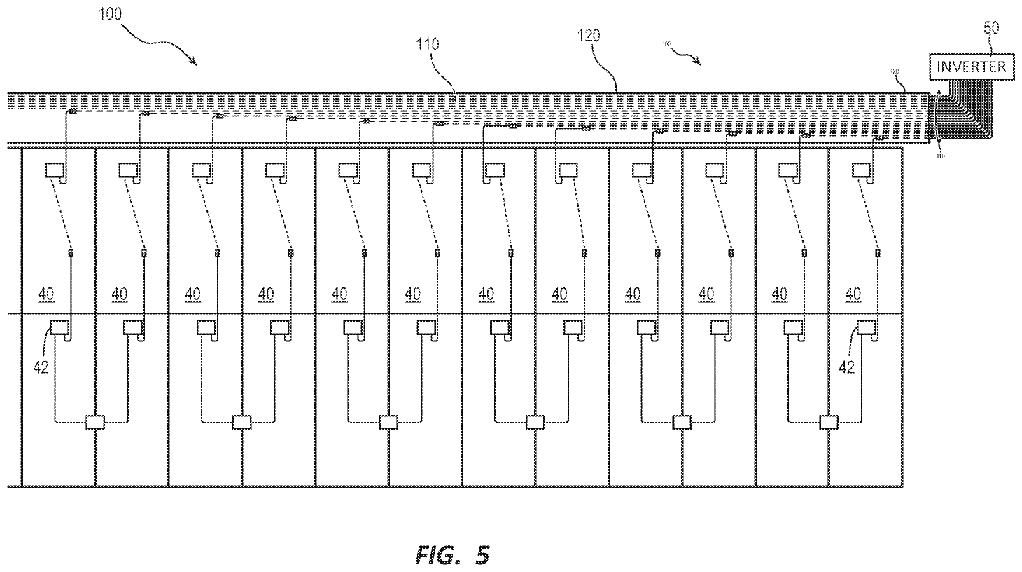

FIG. 4 depicts a plan view of LCA 100. This figure shows terminal ends of cables 110 as LCA 100 runs along a row of modules 40. The figure shows modules 40 in a schematic view of the module bottom. In this version of module 40, junction box 42 sits near the end of module 40 and has positive module lead 44, and negative module lead 46. These leads interact to create module strings. FIG. 5 shows a plan view like that of FIG. 4.

In some exemplars, LCA 100 is used in constructing the utility-scale photovoltaic system or array. One step of this construction process includes extending LCA 100 along a row of modules in which some modules along the row are end modules in a string of modules. In some exemplars, every module in the row of modules is a terminal module in a string of modules. In some exemplars, each module string has an end module that lies in the module row. In some exemplars, the terminal modules in the string lie adjacent to each other in the row of modules.

The row of modules may be formed before the LCA 100 is extended along the row. In other exemplars, LCA 100 is extended, and then the row of modules is placed next to LCA 100. The strings terminated by the row modules may be created before or after row modules are connected to LCA 100. One end of the cables 110 in LCA 100 connects to PV modules, while the other end of each cable 110 connects to a corresponding terminal inside the DC:AC or DC:DC inverter. Sometimes, the location of inverter 50 causes LCA 100 and its individual cables 110 to turn from the row direction to reach inverter 50. Sometimes the cables are routed through conduit or other cable passageways or raceways, and delaminated region 250 allows for easier insertion into such cable protection components.

LCA 100 can be prepared using any method though in the electrical cable technology. For instance, LCA 100 may be prepared as standard, sheathed multi-conductor cables, or other forms known in the art.

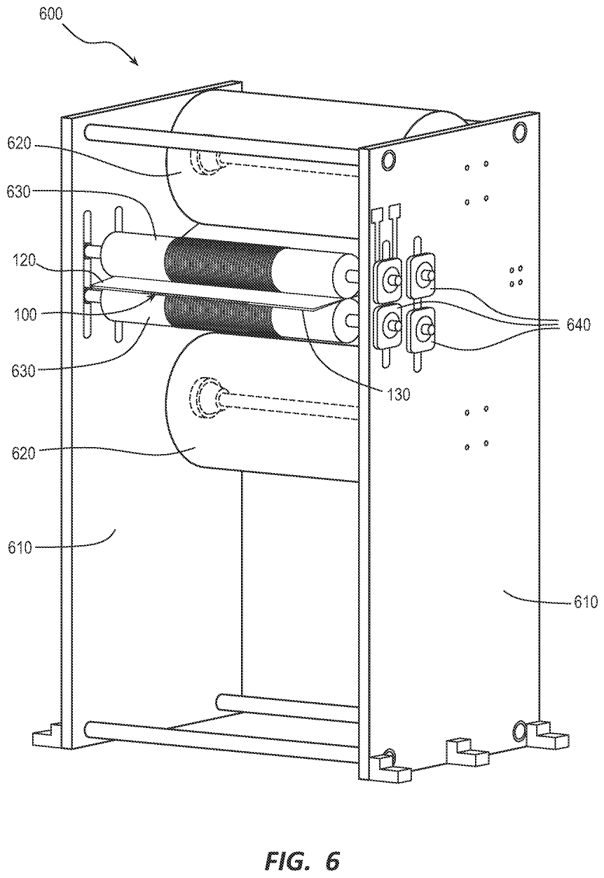

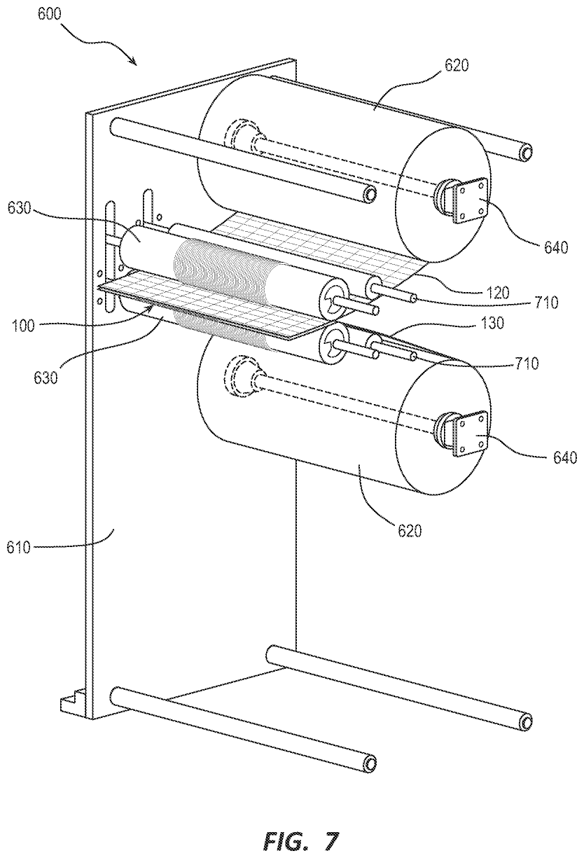

FIG. 6 depicts a laminating machine 600 or apparatus that may produce LCA 100. But many other methodologies as known to those of ordinary skill in the art can produce LCA 100 using similar or different laminating or sheathing machines. Laminating machine 600 has a case 610 with large rollers 620, small rollers 630, and tension roller 710 (see FIG. 7). FIG. 6 also shows bearings 640 for each roller. FIG. 7 depicts laminated machine 600 as before in FIG. 6 with a side of case 610 removed, showing a section of LCA 100 extending out from small rollers 630.

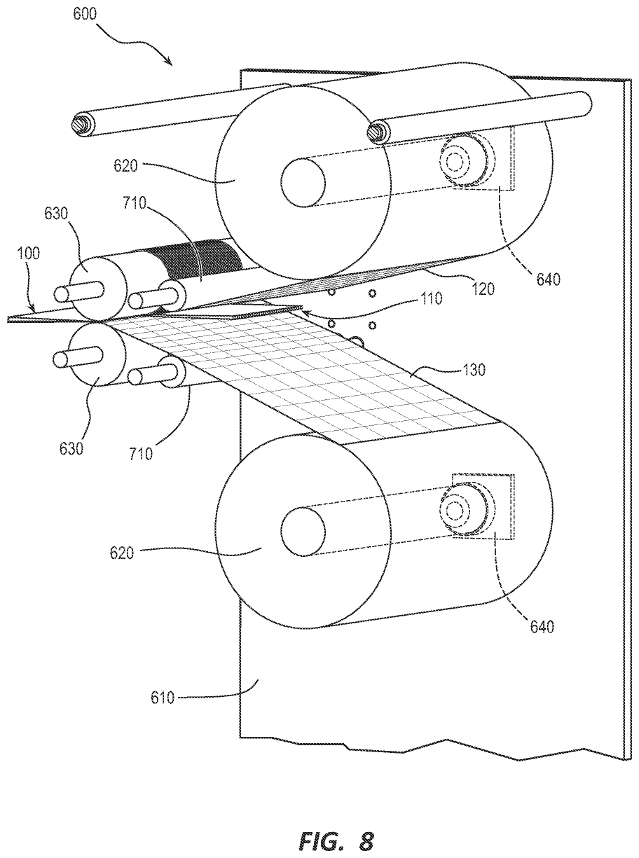

FIG. 8 shows tension roller 710 can be seen. Upper sheet 120 and lower sheet 130 are also depicted spooling from large rollers 620.

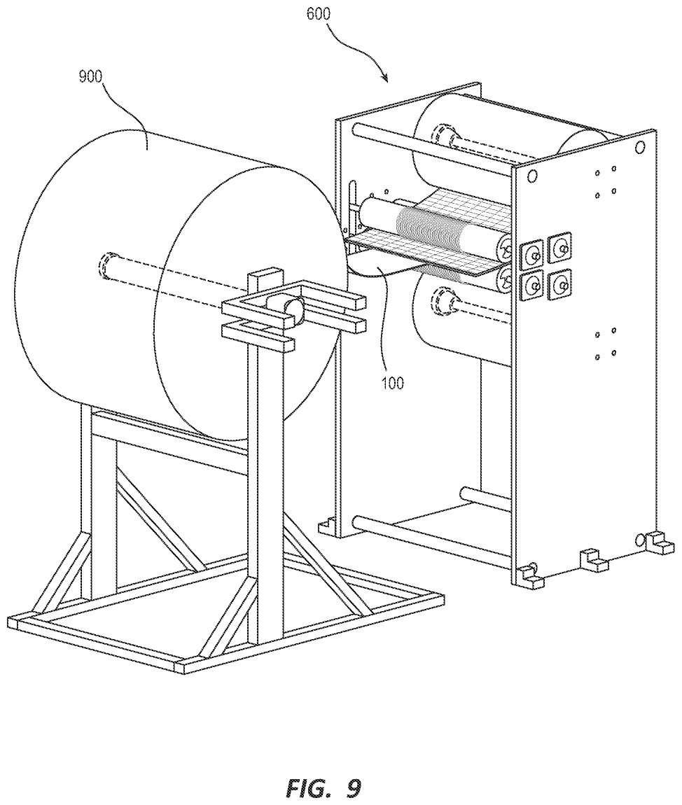

FIG. 9 shows laminating machine 600 and LCA reel 910. LCA reel 910 receives LCA 100 as it exits from small rollers 630.

In operation, several cables 110 are fed into laminating machine 600 between upper sheet 120 and lower sheet 130. Tension rollers 710 provide correct tension on upper sheet 120 and lower sheet 130 as the sheets and individual cables 110 enter between small roller s630. Small rollers 630 press upper sheet 120 against lower sheet 130 and sandwich the individual cables 110 into finished LCA 100. Upper sheet and lower sheet 120, 130 contain adhesive in some exemplars, which causes the sheets to connect and to the individual cables 120. In other exemplars, heat is applied by small rollers 630 to upper sheet 120 and lower sheet 130 as they pass through smaller roller 630. This heat bonds the sheets to each other through activating the substrate or heat-activated adhesives.

Various exemplars have been described above. For convenience's sake, combinations of aspects composing invention exemplars have been listed in such a way that one of ordinary skill in the art may read them exclusive of each other when they are not necessarily intended to be exclusive. But a recitation of an aspect for one exemplar discloses its use in all exemplars in which that aspect can be incorporated without undue experimentation. In like manner, a recitation of an aspect as composing part of an exemplar is an implicit recognition that a supplementary exemplar exists that specifically excludes that aspect. All patents, test procedures, and other documents cited in this specification are incorporated by reference if this material follows this specification and for all jurisdictions in which such incorporation is permitted.

Some exemplars recite ranges. When this is done, it discloses the ranges as a range and discloses every point within the range, including endpoints. For those exemplars that disclose a specific value or condition for an aspect, supplementary exemplars exist that are otherwise identical but that specifically exclude the value or the conditions for the aspect.

What is claimed is:

1. A modular cable assembly adapted to connect PV module strings, which have pairs of end modules, to an inverter wherein the assembly comprises:
cable pairs
and
a sheath containing the cable pairs,
wherein the cable pairs have cable lengths and for a particular cable pair the cable lengths equal the distances between the inverter and a respective one of the pairs of end modules.

2. The assembly of claim 1, wherein the cables have module ends and inverter ends and for a particular cable the sheath secures the cable pair module ends spaced apart from each other.

3. The assembly of claim 2, wherein for greater than 10, 20, 30, 40, 50, 60, 70, or 80% of the cable pairs, the sheath secures the cable pair module ends spaced apart from each other.

4. The assembly of claim 3, wherein for a particular cable the sheath secures the cable pair inverter ends even with each other.

5. The assembly of claim 4, wherein for greater than 10, 20, 30, 40, 50, 60, 70, or 80% of the cable pairs, the sheath secures the cable pair inverter ends even with each other.

6. The assembly of claim 5 comprising greater than 15 cable pairs.

7. The assembly of claim 6, wherein the assembly is adapted for installation under a group of modules.

8. The assembly of claim 7, wherein the sheath groups the cables in one or more vertical layers.

9. The assembly of claim 8, wherein the assembly has an unsheathed region at the inverter end.

10. The assembly of claim 9, wherein sheath comprises 2 layers laminated around the cables.

11. The assembly of claim 10, wherein the cable comprises an insulating material and the sheath comprises a material different from the insulating material.

12. The assembly of claim 11, wherein the sheath comprises markings identifying the cable ends and the array serviced by the assembly.

13. The assembly of claim 12, wherein the assembly comprises greater than 50 cable pairs.

14. The assembly of claim 9, wherein the sheath groups the cables in one vertical layer.

15. The assembly of claim 14, wherein sheath comprises 2 layers laminated around the cables.

16. The assembly of claim 15, wherein the cable comprises an insulating material and the sheath comprises a material different from the insulating material.

17. The assembly of claim 16, wherein the sheath comprises markings identifying the cable ends and the array serviced by the assembly.

18. The assembly of claim 17, wherein connectors are solar module connectors.

19. The assembly of claim 18, wherein the assembly comprises greater than 50 cable pairs.

20. A modular cable assembly adapted to sit along an associated row of pairs of end modules of more than 200 PV module strings and connect the module strings to an inverter wherein the assembly comprises:
more than 100 cable pairs each associates with a module string;
and
a sheath containing the cable pairs,
wherein
the cable pairs have cables with cable lengths, module ends, and inverter ends, each cable pair correlatable with a module string and
each cable correlatable with an end module of an associated module string,
for a particular cable pair the cable lengths equal the distances between the inverter and a respective end module,
for greater than 10, 20, 30, 40, 50, 60, 70, or 80% of the cable pairs, the sheath secures the module ends of a cable pair spaced apart from each other,
for greater than 10, 20, 30, 40, 50, 60, 70, or 80% of the cable pairs, the sheath secures the inverter ends of a cable pair even with each other,
the sheath groups the cable in one vertical layer,
the assembly has an unsheathed region at the inverter ends,
and
the assembly is adapted for installation under a group of the associated modules or a group of unassociated modules.
